(19) United States
(12) Patent Application Publication
(10) Pub. No.: US 2006/0193147 A1
(43) Pub. Date: Aug. 31, 2006

(54) Light guide and illumination apparatus

(75) Inventor: Masatomo Inoue, Mie (JP)

Correspondence Address: OLIFF & BERRIDGE, PLC, P.O. BOX 19928, ALEXANDRIA, VA, 22320, US

(73) Assignee: Sumitomo Wiring Systems, LTD., Mie (JP)

(21) Appl. No.: 11/325,335

(22) Filed: Jan. 5, 2006

(30) Foreign Application Priority Data
Feb. 25, 2005 (JP) 2005-051628

(51) Int. Cl. F21V 7/04

(52) U.S. Cl. 362/602

(57) ABSTRACT

A light guide is arranged between a light source and a section for illumination disposed not directly in front of the light source to introduce light irradiated from the light source onto the section for illumination. The light guide includes an incident surface disposed in front side of the light source, a light distribution surface disposed behind the section for illumination, and a reflection surface opposed to the light source. The reflection surface reflects the light transmitted through the incident surface onto an area within a given angular range around the light source. The light reflected from the reflection surface is directed onto the light distribution surface. The light guide can efficiently utilize light from a light source as illumination.

Patent Application No. JP 2005-051628, filed Feb. 25, 2005 in Japan, is hereby incorporated by reference in its entirety.

This invention relates to a technology of an illumination apparatus having an illumination function for a panel.

### BACKGROUND

Japanese Laid-Open Patent Application No. 2000-106049 (JP-A-2000-106049) (hereinafter “JP-049”) discloses an illumination apparatus which illuminates switch buttons of an audio apparatus for a motor vehicle at the rear side of the buttons. Such a type of illumination apparatus is disposed between a casing of the audio apparatus for a motor vehicle and a board contained in the casing. The illumination apparatus includes a light guide that introduces light irradiated from a light source mounted on the board onto the rear side of the switch buttons.

In more detail, the light guide contains the light source in a recess provided in the rear side of the light guide to reflect the light irradiated laterally from the light source onto the front side, thereby lighting a light distribution surface shifted laterally from an area of the front side of the light source and illuminating the switch buttons mounted on the front side of the light distribution surface.

However, the illumination apparatus disclosed (see JP-049) could not introduce efficiently irradiated light from the light source onto the light distribution surface.

That is, the light irradiated laterally from the light source is reflected and directed onto the light distribution surface in the illumination apparatus disclosed in JP-049. However, the illumination apparatus could not introduce efficiently irradiated light from the light source onto the light distribution surface. The strongest light directed to the front side from the light irradiated from the light source escaped from the light guide and could not contribute to illumination for the buttons.

In view of the above problems, an object of the present invention is to provide a light guide that can efficiently utilize light from a light source as illumination and an illumination apparatus provided with the light guide.

### SUMMARY

In order to achieve the above object, exemplary embodiments of the present invention are directed to a light guide arranged between a light source and a section for illumination disposed laterally out of a front side of the light source to introduce light irradiated from the light source onto the section for illumination. The light guide comprises: an incident surface disposed on the front side of the light source; a light distribution surface disposed on a rear side of the section for illumination; and a reflection surface opposed to the light source through the incident surface. The reflection surface reflects the light transmitted through the incident surface onto an area within a given angular range around the light source and the light reflected from the reflection surface is reflected onto the light distribution surface.

According to exemplary embodiments it is possible to effectively utilize the light irradiated from the light source as light for lighting the light distribution surface, since the reflection surface opposed to the light source through the incident surface can reflect laterally the light transmitted through the incident surface to the side of the light source.

Therefore, it is possible to efficiently utilize the light from the light source for the purpose of illumination.

Although a reflection surface may merely reflect light immediately around the light source within a given range, it will be preferable that the reflection surface reflect the light transmitted through the incident surface onto a greater area around the light source.

According to this structure, it is possible to reflect laterally the light irradiated from the light source to the front side of a reflection surface onto the whole area around the light source.

Although the reflection surface may be merely a non-uniform side sectional shape within a given angular range, it will be preferable that the reflection surface has a substantially uniform side sectional shape through the given angular range.

According to this structure, it is possible to reflect the light having substantially uniform intensity through the given angular range.

A configuration of the reflection surface is not limited. However, preferably, the front side of the light guide disposed on the front side of the light source defines the reflection surface, the front side of the light guide is concaved toward the light source to form a cavity, and an apex of the cavity is disposed on an optical axis extending from the light source to the front side of the light guide.

According to this structure, it is possible to reflect the light irradiated from the light source to the front side of reflection surface onto the whole area around the optical axis, since the side wall of the cavity, of which the apex is disposed on the optical axis, can be utilized as the reflection surface.

In another aspect of exemplary embodiments of the present invention, an illumination apparatus includes the light guide described above, a light source for irradiating the light guide, and a panel for covering the light guide and the light source. The light distribution surface of the light guide lighted by the light irradiated from the light source illuminates the section for illumination on the panel at the rear side of the section. The section for illumination is formed out of the front side of the light source.

According to the above aspect, it is possible to illuminate the section for illumination by the light distribution surface while the light guide effectively utilizes the light irradiated from the light source to the front side.

According to exemplary embodiments of the present invention, it is possible to effectively utilize the light, irradiated from the light source to the front side, as light for lighting the light distribution surface, since the reflection surface opposed to the light source through the incident surface can reflect the light transmitted through the incident surface laterally from the light source.

Therefore, it is possible to efficiently utilize the light from the light source for the purpose of illumination.

### BRIEF DESCRIPTION OF THE DRAWINGS

Exemplary embodiments will be described below with reference to the drawings, in which like numerals represent like parts, and in which:

FIG. 1 is an exploded perspective view of an audio apparatus for a motor vehicle in connection with an embodiment of the present invention;

FIG. 2a is a plan view of a light guide shown in FIG. 1, illustrating a relationship in position between the light guide and LEDs;

FIG. 2b is a plan view of the light guide shown in FIG. 1, illustrating behavior of light irradiated from the LEDs;

FIG. 3a is a sectional view of the light guide taken along line III-III in FIG. 2a, illustrating a relationship in position between the LED and the light guide;

FIG. 3b is a sectional view of the light guide taken along line III-III in FIG. 2a, illustrating behavior of light irradiated from the LED;

FIG. 4a is a plan view of another embodiment of the light guide in accordance with the present invention, illustrating the light guide combined with a single LED;

FIG. 4b is a plan view of another embodiment of the light guide in accordance with the present invention, illustrating the light guide combined with two LEDs; and

FIG. 5 is a plan view of still another embodiment of the light guide in accordance with the present invention.

### DETAILED DESCRIPTION OF EMBODIMENTS

Referring now to the drawings, exemplary embodiments of a light guide and an audio apparatus provided with the light guide will be explained below.

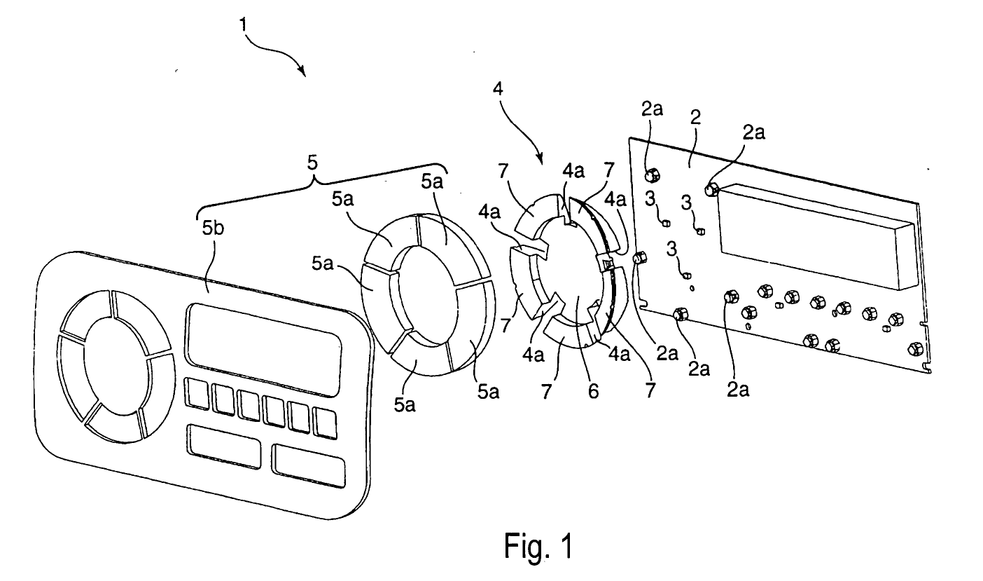

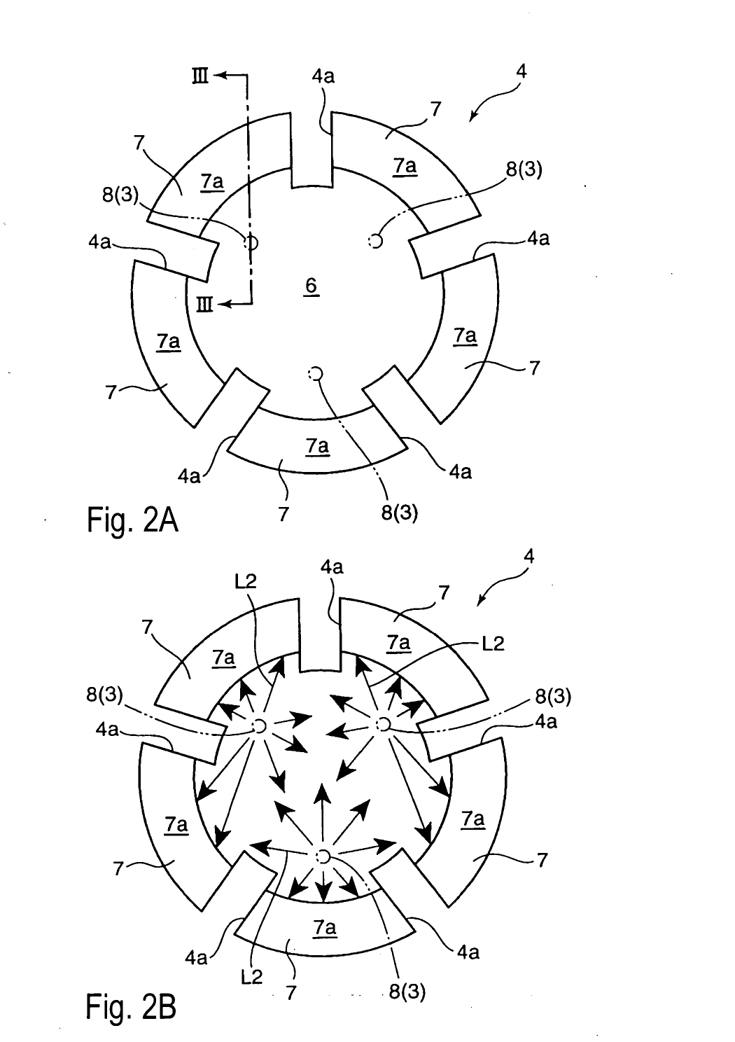

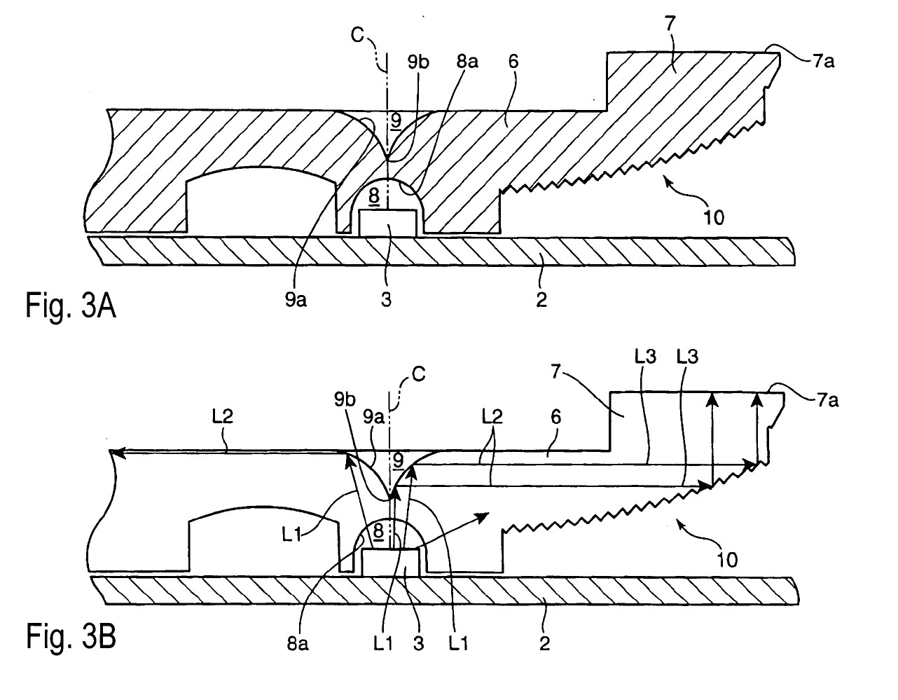

FIG. 1 is an exploded perspective view of an audio apparatus for a motor vehicle in connection with an embodiment of the present invention. FIG. 2a is a plan view of a light guide 4 shown in FIG. 1, illustrating a relationship in position between the light guide 4 and LEDs 3. FIG. 2b is a plan view of the light guide 4 shown in FIG. 1, illustrating behavior of light irradiated from the LEDs 3. FIG. 3a is a sectional view of the light guide taken along line III-III in FIG. 2a, illustrating a relationship in position between the LED 3 and the light guide 4. FIG. 3b is a sectional view of the light guide 4 taken along line III-III in FIG. 2a, illustrating behavior of light irradiated from the LED 3.

Referring to FIGS. 1 to 3, an audio apparatus 1 for a motor vehicle includes a board 2, a light guide 4 mounted on the board 2 to cover three LEDs (light source) 3 mounted on the board 2, and a panel 5 that covers the board 2 and light guide 4. The light irradiated through the light guide 4 from the respective LEDs 3 illuminates five switch buttons 5a on the panel 5 at the rear side of the buttons 5a.

The light guide 4 may be made of a synthetic resin material having light transmission properties, such as a methacrylate resin or the like. The light guide 4 includes a substantially disk-like body portion 6 of which peripheral edge portion is divided into, for example, five sections by five slits 4a extending radially, and five protrusions 7 projecting toward a front side on the peripheral edge portion with a given width. In the present embodiment, a front side (end surface) of each protrusion 7 defines a light distribution surface 7a (FIGS. 2a, 2b, 3a, 3b). Each switch button 5a is mounted on a respective protrusion 7.

The body portion 6 is provided in a rear side with, for example, three recesses 8 (FIGS. 3a-3b). Each LED 3 is contained in a respective recess 8. That is, in the present embodiment, a bottom surface of each recess 8 defines an incident surface 8a. The incident surface 8a is arranged at the front side of each LED 3. Light irradiated from the respective LEDs 3 enters the light guide 4 through the respective incident surfaces 8a.

On the other hand, the body portion 6 is provided in a front surface (an upper surface in FIGS. 3a and 3b) with cavities 9 opposed to the respective LEDs 3 through the incident surfaces 8a. Each cavity 9 is preferably circular and concentrically disposed with each LED 3 in a plan view. FIG. 3a, the cavity 9 has a substantially isosceles triangle configuration in a side sectional view. The isosceles triangle has two equal slant sides that are curved outwardly. The bottom side of the isosceles triangle extends over the LED 3 in a plan view. That is, an apex 9b of the cavity 9 is disposed on an optical axis C directed from the LED 3 to the front side and the cavity 9 has a uniform shape in a side sectional view (uniform side sectional shape) about the optical axis C. In the present embodiment, the slant sides of the cavity 9 define the reflection surface 9a.

Accordingly, as shown in FIGS. 2b and FIG. 3b, the light (shown by an arrow L1 in FIG. 3b) irradiated through the incident surface 8a from the LED 3 is reflected in a lateral direction (shown by an arrow L2 in FIG. 3b) substantially parallel to the board 2 by the reflection surface 9a opposed to the incident surface 8a. Then, since the cavity 9 has a uniform side sectional shape about the optical axis C, the light L2 reflected on the reflection surface 9a has a uniform intensity about the optical axis C. In the case of a conventional light guide on which the reflection surface 9a is not provided (a front side of the body portion 6 is flat), since the light irradiated from the LED 3 to the front side strikes vertically on the front side of the body portion 6, the majority of the light will pass through the body portion 6. On the contrary, in the case where the light guide 4 is provided with the reflection surface 9a in the present embodiment, the majority of the light (shown by the arrow L2 in FIGS. 2b and FIG. 3b) is reflected laterally, since the light irradiated from the LED 3 to the front side strikes the reflection surface 9a with a relatively high incident angle.

Furthermore, the body portion 6 is preferably formed into a curved configuration, such as a punch bowl, at a peripheral area with a given width on the rear side of the body portion 6. The curved configuration is preferably provided with a knurled surface 10. The knurled surface 10, as shown in FIG. 3b, may be a slant surface (inclined at about 45 degrees with respect to the board 2) with a plurality of irregularities that lead the irradiated light L2, guided laterally from the reflection surface 9a, to the front side, namely to the side of the protrusions 7, as shown by an arrow L3.

Referring to FIG. 1, at least a part of the switch button 5a is made of an optically transparent material to transmit the light irradiated from the light guide 4 to the front side. The switch button 5a is mounted on the protrusion 7 of the light guide 4 so as to move outwardly and inwardly from a panel body 5b of the panel 5. When the switch button 5a is pushed into the inner side (inner part) of the panel body 5b, each of five switches 2a, which may be micro switches or any other desired type of switch, on the board 2 can be pushed down individually through the light guide 4.

As described above, according to the present embodiment, it is possible to effectively utilize the light irradiated from the LED 3 as light for lighting the light distribution surface 7a, since the reflection surface 9a opposed to the LED 3 through the incident surface 8a can reflect laterally the light transmitted through the incident surface 8a from the LED 3.

Accordingly, it is possible to efficiently utilize the light from the LED 3 in accordance with the present embodiment.

In the above embodiment, it is possible to reflect the light irradiated from the LED 3 to the front side to a whole periphery of the reflection surface 9a about the optical axis C, since the side wall of the cavity 9 of which the apex 9b is disposed on the optical axis C defines the reflection surface 9a.

Furthermore, in the above embodiment, it is possible to reflect the light irradiated from the LED 3 to the front side to the whole periphery of the area around the LED 3 (optical axis C) with a substantially uniform intensity, since the side sectional shape of the cavity 9 is uniform about the LED 3 (optical axis C).

Although the present embodiment includes the light guide 4 in which the whole area of the light distribution surfaces 7a is shifted laterally from the front side of the LED 3, it is also acceptable if only a part of the light distribution surfaces 7a is shifted from the front side of the LED 3. That is, the present invention does not exclude a light guide in which the light distribution surfaces are disposed on the front side of the light source. According to the above embodiment, it is possible to effectively utilize the light irradiated from the LED 3 to the front side as the light for lighting the area of the light distribution surfaces 7a shifted from the front side of the LED 3 (hereinafter referred to “non-front side area”) by reflecting laterally the irradiated light by the reflection surface 9a to detour the irradiated light.

Although the present embodiment includes the cavity 9 that forms the reflection surface having a substantially isosceles triangle in a side sectional view in which the isosceles sides are curved outwardly, the present invention does not limit a specific shape of the reflection surface. For example, a conical cavity 9 that has two slant sides of the isosceles triangular formed straightly in the side sectional view and the straight slant sides may define the reflection surface 9a.

In addition, although the light guide 4 includes three LEDs 3 in the above embodiment, the number of the LEDs in the light guide 4 is not limited.

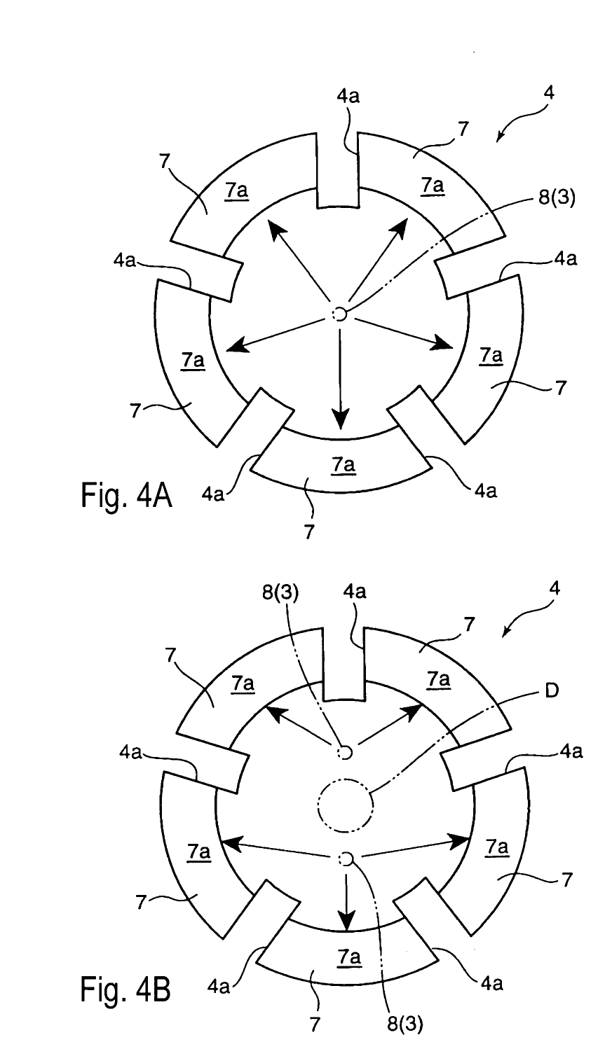

For example, as shown in FIG. 4a, the recess 8 and cavity 9 may be disposed on the center of the body portion 6 and a single LED 3 may be used in connection with the recess 8. This can substantially lighten uniformly the respective light distribution surfaces 7 spaced away by an equal distance from the LED 3.

On the other hand, as shown in FIG. 4b, even if the LED 3 cannot be disposed on the center of the body portion 6 due to a layout condition of another element D to be mounted on the board 2, it is possible to lighten the light distribution surfaces 7a by arranging the recesses 8 and cavities 9 on the opposite sides of the element D to utilize the light irradiated from two LEDs 3 contained the recesses 8. Furthermore, the number of the LEDs 3 may be three or more.

Also, in the above embodiment, although the reflection surface 9a is formed around the LED 3 through 360 degrees, the present invention is not limited to this structure. The reflection surface 9a may be formed around the LED 3 within a given circumference less than 360 degrees in association with a position of the light distribution surface 7a.

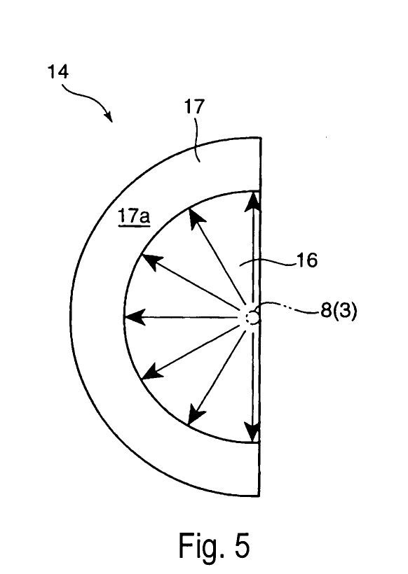

For example, as shown in FIG. 5, in the case where a light guide 14 includes a semi-circular body portion 16 and a protrusion 17 (a front side defines a light distribution surface 17a) projecting to the front surface along a peripheral edge portion of the body portion 16, the reflection surface 9a may be formed around the LED 3 through 180 degrees in connection with an arranging direction of the protrusion 17.

Although the apex 9b of the cavity 9 is disposed on the optical axis C in the above embodiment, it is possible to suitably adjust a position of the apex 9b so that the reflection surface 9a can reflect the light irradiated from the LED 3 to the front side within a given range in angle about the LED 3 (optical axis C).

Furthermore, in the above embodiment, although the cavity 9 has the uniform side sectional shape about the LED 3 (optical axis C), the side sectional shape of the cavity 9 may not be uniform. For example, in the case where intensity of light reflected to a specific direction about the optical axis C is great while intensity of light reflected to the other direction is small, it is possible to form the cavity 9 so that an area of the reflection surface for reflecting the light to the specific direction is great and an area of the reflection surface for reflecting the light to the other direction is small.

What is claimed is:

1. A light guide arranged between a light source and a section for illumination to introduce light irradiated from the light source onto the section for illumination, the light guide comprising:
an incident surface disposed in front of the light source;
a light distribution surface disposed behind the section for illumination; and
a reflection surface opposed to said light source;
wherein the reflection surface reflects the light transmitted through the incident surface onto an area within a given angular range around the light source and the light reflected from the reflection surface are directed onto the light distribution surface.

2. A light guide according to claim 1, wherein the light transmitted through the incident surface is reflected onto a whole area around said light source.

3. A light guide according to claim 1, wherein the reflection surface has a substantially uniform side sectional shape through said given angular range.

4. A light guide according to claim 1, wherein the front side of the light guide disposed on the front side of the light source defines the reflection surface, the front side of the light guide is concave toward the light source to form a cavity, and an apex of the cavity is disposed on an optical axis extending from the light source to the front of the light source.

5. An illumination apparatus comprising:
a light guide according to claim 1;
a light source that irradiates the light guide; and
a panel that covers the light guide and the light source;
wherein the light distribution surface of the light guide lighted by the light irradiated from the light source illuminates the section for illumination on the panel behind the section, the section not being directly in front of the light source.

6. An illumination apparatus comprising:
a light guide according to claim 2;
a light source that irradiates the light guide; and
a panel that covers the light guide and the light source;
wherein the light distribution surface of the light guide lighted by the light irradiated from the light source illuminates the section for illumination on the panel behind the section, the section not being directly in front of the light source.

7. An illumination apparatus comprising:
a light guide according to claim 3;
a light source that irradiates the light guide; and
a panel that covers the light guide and the light source;
wherein the light distribution surface of the light guide lighted by the light irradiated from the light source illuminates the section for illumination on the panel behind the section, the section not being directly in front of the light source.

8. An illumination apparatus comprising:
a light guide according to claim 4;
a light source that irradiates the light guide; and
a panel that covers the light guide and the light source;
wherein the light distribution surface of the light guide lighted by the light irradiated from the light source illuminates the section for illumination on the panel behind the section, the section not being directly in front of the light source.
